(19) United States
(12) Patent Application Publication
(10) Pub. No.: US 2010/0149144 A1
(43) Pub. Date: Jun. 17, 2010

(54) PLASMA DISPLAY AND DRIVING APPARATUS THEREOF

(75) Inventors: Jae-Kwang LIM, Suwon-si (KR); Chan-Kyu Jang, Suwon-si (KR); Suk-Jae Park, Suwon-si (KR); Heung-Sik Tae, Suwon-si (KR); Suk-Ki Kim, Suwon-si (KR); Jung-Pil Park, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 12/638,742

(22) Filed: Dec. 15, 2009

(30) Foreign Application Priority Data
Dec. 15, 2008 (KR) 10-2008-0127248

(51) Int. Cl. G09G 5/00; G09G 3/28

(52) U.S. Cl. 345/205; 345/60

(57) ABSTRACT

A plasma display is disclosed. In one aspect, the display includes a scan driving board that applies a sustain pulse to a scan electrode during a sustain period and a sustain driving board that applies a sustain pulse to a sustain electrode during the sustain period. The scan driving board and the sustain driving board are connected by a harness. Ground wires are disposed at both sides of the harness and main path wires are disposed between the ground wires.

### CROSS-REFERENCE TO RELATED APPLICATION

This application claims priority to and the benefit of Korean Patent Application No. 10-2008-0127248 filed in the Korean Intellectual Property Office on Dec. 15, 2008, the entire contents of which are incorporated herein by reference.

### BACKGROUND

1. Field

The technology relates to a plasma display and a driving apparatus thereof. More particularly, the technology relates to a driving circuit during a sustain period.

2. Description of the Related Technology

A plasma display uses a plasma display panel that displays texts or images by using plasma generated by gas discharge. A plurality of cells are arranged in matrix on the plasma display panel.

In general, the plasma display drives frames which are each divided into a plurality of sub-fields and a gray scale is displayed by a combination of weighted values of sub-fields in which a display operation is performed among the plurality of subfields. Light emitting cells and non-emission cells are selected during an address period of each sub-field. A sustain discharge is performed for the light emitting cells in order to display images during a sustain period.

In particular, in order to display the images during the sustain period, sustain pulses having a high-level voltage and a low-level voltage are alternately applied to a scan electrode and a sustain electrode that perform the sustain discharge. Because the two electrodes that perform the sustain discharge are capacitive elements, reactive power is required to apply the high-level voltage or the low-level voltage to the two electrodes. Accordingly, a scan driving board for driving the scan electrode and a sustain driving board for driving the sustain electrode include an energy recovery circuit that recovers and reuses some of the reactive power. Because the energy recovery circuits generally have the same structure on the two driving boards, the manufacturing cost of the plasma display may be unnecessarily higher. Therefore, there is needed a method of applying the sustain pulses to the scan electrode and the sustain electrode by using one energy recovery circuit. However, in the case of using the one energy recovery circuit, energy recovery efficiency may vary depending on a method of connecting the energy recovery circuit to each of the scan electrode and the sustain electrode and parasitic elements which result.

### SUMMARY OF CERTAIN INVENTIVE ASPECTS

One aspect is a plasma display panel, comprising first and second electrodes that extend in one direction; a first driving unit configured to apply a first sustain pulse alternately having first and second voltages to the first electrode during a sustain period; a second driving unit configured to apply a second sustain pulse alternately having third and fourth voltages to the second electrode in a phase opposite to the first sustain pulse during the sustain period; and a harness connecting the first driving unit and the second driving unit to each other, wherein the harness includes a plurality of ground wires and a plurality of main path wires that are disposed between the plurality of ground wires.

Another aspect is a driving apparatus of a plasma display including first and second electrodes that extend in one direction, the driving apparatus comprising a first driving board configured to drive the first electrode; a second driving board configured to drive the second electrode; and a harness connecting the first driving board and the second driving board, wherein the harness comprises a plurality of ground wires and a plurality of main path wires that are disposed between the plurality of ground wires.

Yet another aspect is a plasma display, comprising first and second driving units configured to apply sustain pulses to first and second electrodes during a sustain period; and a harness connecting the first driving unit and the second driving unit, wherein the harness comprises a plurality of ground wires and a plurality of main path wires that are disposed between the plurality of ground wires, and wherein the harness forms an inductive component of an energy recovery circuit for the first and second driving units.

### BRIEF DESCRIPTION OF THE DRAWINGS

FIG. 1 is an exploded perspective view of a plasma display according to an exemplary embodiment;

FIG. 2 is a schematic conceptual diagram of a plasma display panel according to an exemplary embodiment;

FIG. 3 is a schematic plan view of a chassis base according to an exemplary embodiment;

FIGS. 4 and 5 are diagrams illustrating a driving waveform of a plasma display according to first and second exemplary embodiments;

FIG. 6 is a diagram illustrating a driving circuit according to a first exemplary embodiment;

FIG. 7 is a signal timing diagram of the driving circuit of FIG. 6 for generating a sustain pulse shown in FIG. 4;

FIGS. 8A and 8B are diagrams illustrating a current path depending on a signal timing shown in FIG. 6;

FIG. 9 is a schematic plan view of a structure of a harness according to an exemplary embodiment;

FIGS. 10A and 10B are diagrams illustrating a current direction in a harness wire;

FIG. 11 is a diagram illustrating a driving circuit according to a second exemplary embodiment;

FIG. 12 is a signal timing diagram of the driving circuit of FIG. 11 for generating a sustain pulse shown in FIG. 4;

FIGS. 13A and 13B are diagrams illustrating a current path depending on a signal timing shown in FIG. 12;

FIG. 14 is a signal timing diagram of the driving circuit of FIG. 11 for generating a sustain pulse shown in FIG. 5; and

FIGS. 15A and 15B are diagrams illustrating a current path depending on a signal timing shown in FIG. 14.

### DETAILED DESCRIPTION OF CERTAIN INVENTIVE EMBODIMENTS

In the detailed description, only certain exemplary embodiments have been shown and described, simply by way of illustration. As those skilled in the art would realize, the described embodiments may be modified in various different ways.

Accordingly, the drawings and description are to be regarded as illustrative in nature and not restrictive. Like reference numerals generally designate like elements throughout the specification. When any one part is connected with another part the parts may be directly connected with each other and may be connected with each other with other elements interposed therebetween.

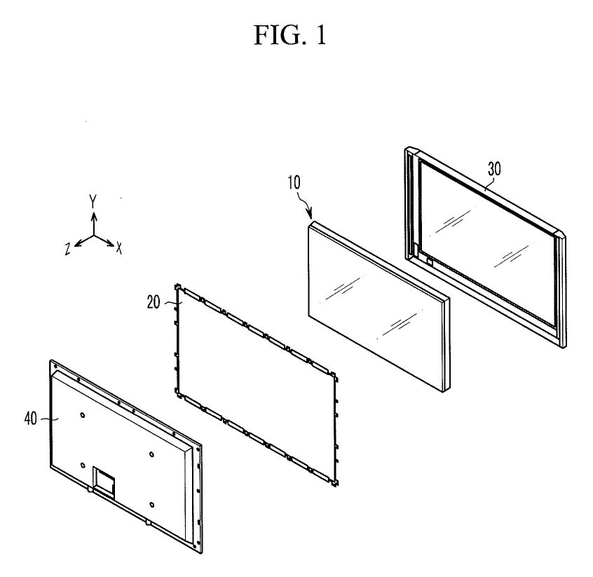

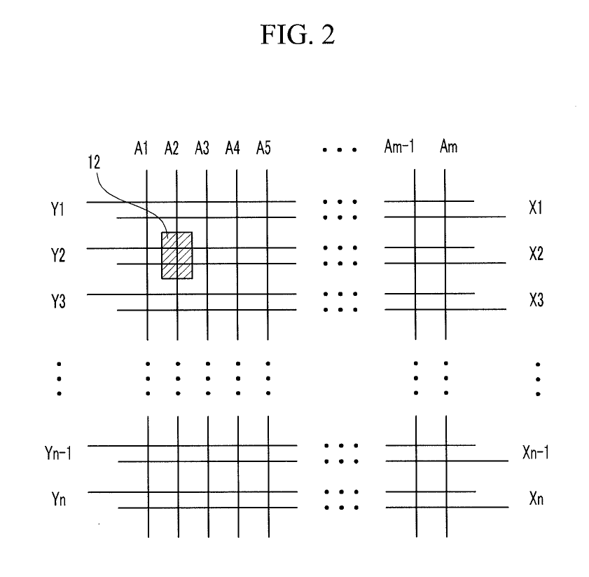

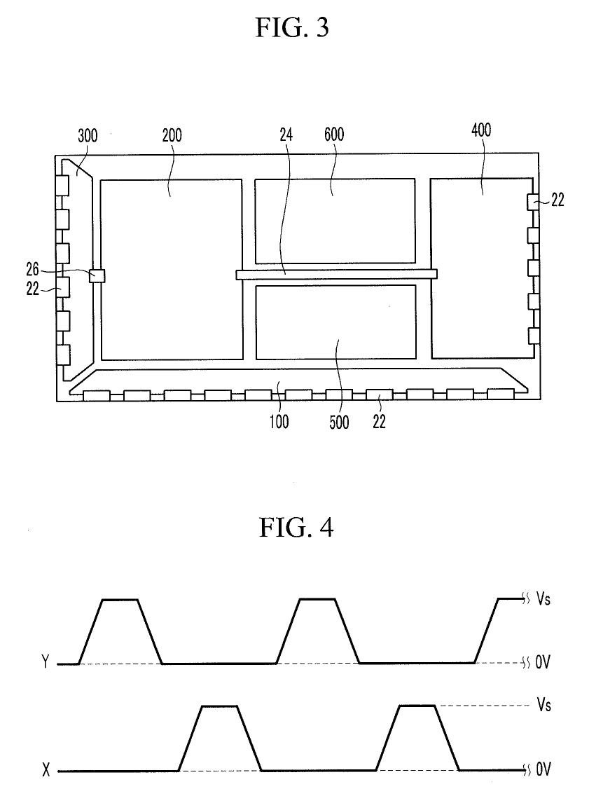

FIG. 1 is an exploded perspective view of a plasma display according to an exemplary embodiment. FIG. 2 is a schematic conceptual diagram of a plasma display panel according to an exemplary embodiment, and FIG. 3 is a schematic plan view of a chassis base according to an exemplary embodiment.

Referring to FIG. 1, an exemplary plasma display includes a display panel 10, a chassis base 20, a front case 30, and a rear case 40. The chassis base 20 is disposed at a side opposite to a surface on which images are displayed in the plasma display panel 10. The front and rear cases 30 and 40 are disposed on a front surface of the plasma display panel 10 and a rear surface of the chassis base 20, respectively and are coupled with the plasma display panel 10 and the chassis base 20 to form the plasma display device.

Referring to FIG. 2, the plasma display panel 10 includes a plurality of address electrodes (hereinafter, referred to as “A-electrode”) A1 to Am that extend in a column direction thereof, and a plurality of sustain electrodes (hereinafter, referred to as “X-electrode”) X1 to Xn and a plurality of scan electrodes (hereinafter, referred to as “Y-electrode”) Y1 to Yn that extend in pairs in a row direction. In general, the X-electrodes X1 to Xn are formed in correspondence with the Y-electrodes Y1 to Yn, and the X-electrodes X1 to Xn and the Y-electrodes Y1 to Yn perform a display operation for displaying the images during the sustain period. The Y-electrodes Y1 to Yn and the X-electrodes X1 to Xn are disposed perpendicular to the A-electrodes A1 to Am. A discharge space is disposed near intersections of the A-electrodes A1 to Am and the X and Y-electrodes X1 to Xn and Y1 to Yn to form discharge cells (one of which is hereinafter, referred to as “cell” 12). The structure of the plasma display panel 10 is one example and a panel having another structure adopting a driving waveform described below may be used.

Referring to FIG. 3, boards 100 to 600 required for driving the plasma display panel 10 are formed in the chassis base 20.

The address buffer board 100 is formed in any one of an upper portion and a lower portion of the chassis base 20. In FIG. 3, although a plasma display that performs single driving is illustrated as an example, in the case of a plasma display that performs dual driving, the address buffer board 100 is disposed in each of the upper portion and the lower portion of the chassis base 20. The address buffer board 100 receives an A-electrode driving control signal from the control board 500 and applies a driving voltage for selecting light emitting cells and non-emission cells to the A-electrodes A1 to Am in accordance with the received A-electrode driving control signal.

The scan driving board 200 is disposed at a left side of the chassis base 20 and connected with the scan buffer board 300 through a connection member 26 such as conductive patterns, cables, or the like. The scan buffer board 300 is connected to the Y-electrodes Y1 to Yn through a flexible printed circuit (FPC) 22. The scan driving board 200 receives a Y-electrode driving control signal from the control board 500 and applies the driving voltage to the Y-electrodes Y1 to Yn in accordance with the received Y-electrode driving control signal. Although in this embodiment, the scan driving board 200 and the scan buffer board 300 are disposed at the left side of the chassis base 20, in other embodiments they are disposed at a right side of the chassis base 20. Further, the scan buffer board 300 may be integrated with the scan driving board 200.

The sustain driving board 400 is disposed at the right side of the chassis base 20. The sustain driving board 400 is connected with the scan driving board 200 through a harness 24 and is connected to the X-electrodes X1 to Xn through the flexible printed circuit (FPC) 22. The scan driving board 400 receives an X-electrode driving control signal from the control board 500 and applies the driving voltage to the X-electrodes X1 to Xn in accordance with the received X-electrode driving control signal.

The control board 500 receives image signals for each frame, thus, the control board 500 generates the A-electrode driving control signal, the Y-electrode driving control signal, and the X-electrode driving control signal and outputs the signals to the address, scan, and sustain driving boards 100, 200, and 400, respectively. Further, the frame is divided into a plurality of sub-fields each having weighted values, where each sub-field includes an address period and a sustain period.

The control board 500 and the power supply board 600 may be disposed at the center of the chassis base 20. The power supply board 600 supplies an electric power required to drive the plasma display to the boards 100 to 500.

Herein, the address buffer board 100, the scan driving board 200, and the sustain driving board 400 form driving units that drive the A-electrodes, the Y-electrodes, and the X-electrodes. The control board 500 forms a control unit that controls the driving units. The power supply board 600 forms a power supply unit that supplies the power to the driving units and the control unit.

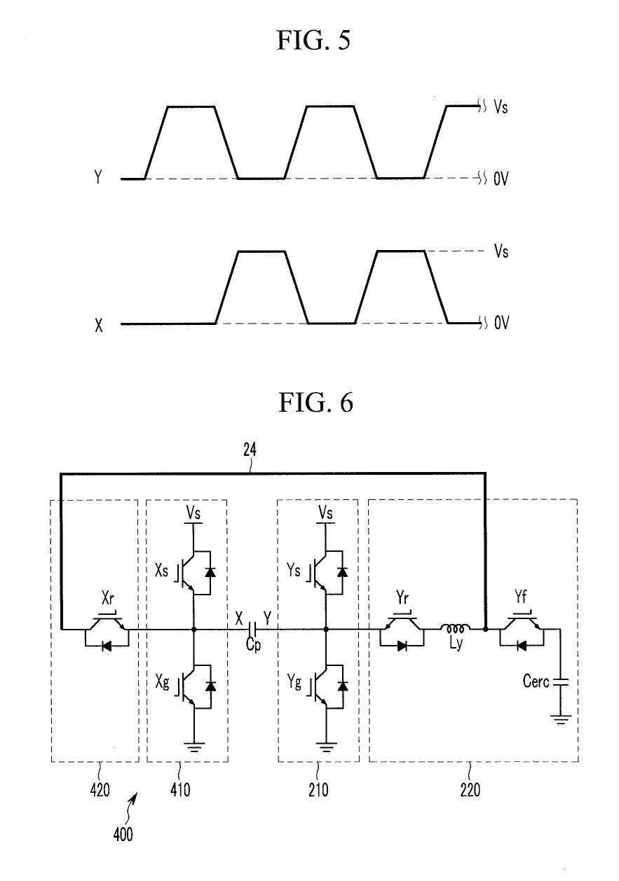

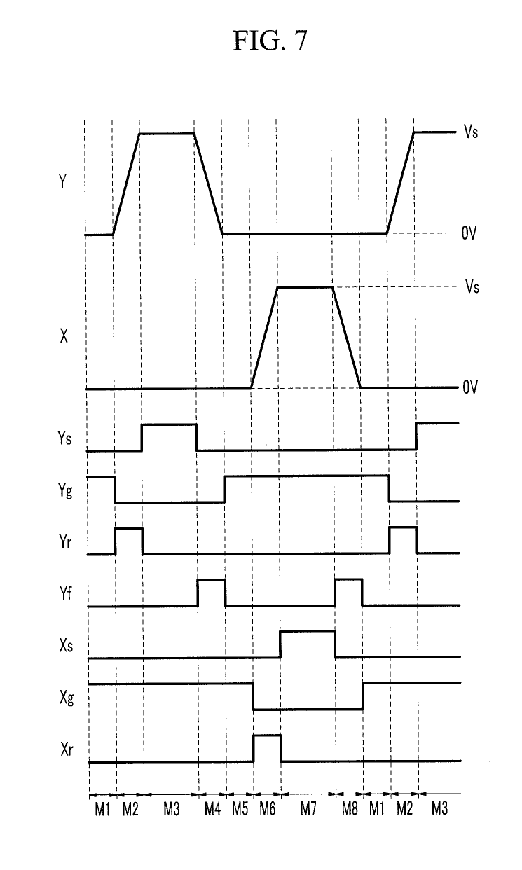

FIGS. 4 and 5 are timing diagrams illustrating driving waveforms for a plasma display according to first and second exemplary embodiments. In FIGS. 4 and 5, only driving waveforms during the sustain period are illustrated.

Referring to FIG. 4, the scan driving board 200 applies a sustain pulse alternately having a high-level voltage Vs and a low-level voltage 0V to the Y-electrodes Y1 to Yn for a number of times corresponding to the weighted value of the current sub-field. In addition, the sustain driving board 400 applies a sustain pulse to the X-electrodes X1 to Xn in a phase opposite to the sustain pulse applied to the Y-electrodes Y1 to Yn. That is, when the voltage Vs is applied to the Y-electrodes, the voltage 0V is applied to the X-electrodes and when the voltage 0V is applied to the Y-electrodes, the voltage Vs is applied to the X-electrodes.

By this operation, voltage differences between the X-electrodes X1 to Xn and the Y-electrodes Y1 to Yn alternately have the voltage Vs and the voltage −Vs, such that a sustain discharge repetitively occurs in the light emitting cell for the weighted duration of sustain portion of the sub-field.

As shown in FIG. 5, during the sustain period, when the voltage of the Y-electrode is changed from the voltage 0V to the voltage Vs, the voltage of the X-electrode may be also changed from the voltage Vs to the voltage 0V and when the voltage of the Y-electrode is changed from the voltage Vs to the voltage 0V, the voltage of the X-electrode may be changed from the voltage 0V to the voltage Vs. With this operation, the voltage difference between the X-electrodes X1 to Xn and the Y-electrodes Y1 to Yn alternately has the voltage Vs and the voltage −Vs, such that the sustain discharge repetitively occurs in the light emitting cell for a duration corresponding to the weighted value of the sub-field.

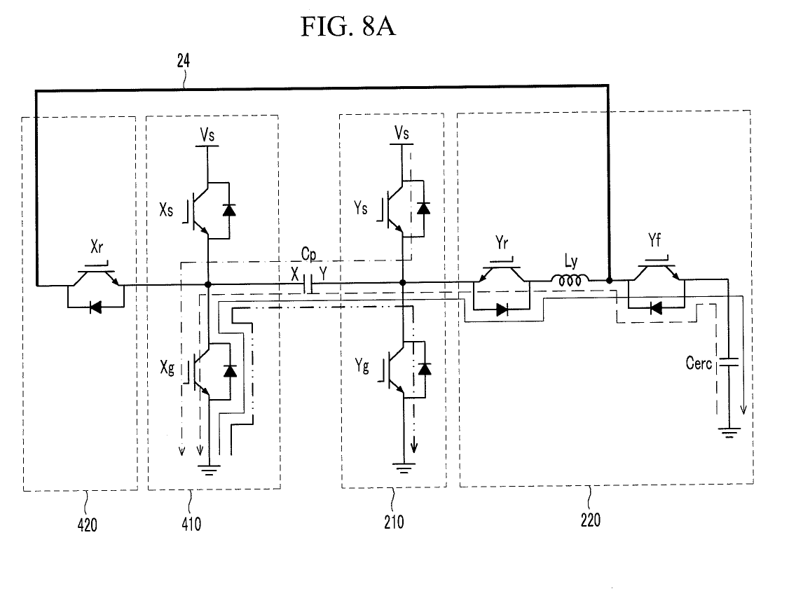

FIG. 6 is a circuit diagram illustrating a driving circuit according to a first exemplary embodiment. In FIG. 6, only one X-electrode and only one Y-electrode are illustrated for better understanding and ease of description and capacitive elements formed by the X-electrodes and the Y-electrodes are represented by a panel capacitor Cp. Further, in FIG. 6, transistors Ys, Yg, Yr, Yf, Xs, Xg, and Xr are illustrated as n-channel insulated gate bipolar transistors (IGBT). In the transistors Ys, Yg, Yr, Yf, Xs, Xg, and Xr, body diodes are formed in a direction from an emitter to a collector. In other embodiments, other transistors that perform a similar function as the IGBT may be used as the transistors Ys, Yg, Yr, Yf, Xs, Xg, and Xr instead of the IGBT.

Referring to FIG. 6, the scan driving board 200 includes a sustain discharge unit 210 and an energy recovery unit 220 and the sustain driving board 400 includes a sustain discharge unit 410 and the energy recovery unit 420.

The sustain discharge unit 210 includes the transistors Ys and Yg and the sustain discharge unit 410 includes the transistors Xs and Xg. Collectors of the transistors Ys and Xs are connected to the power supply Vs that supplies the high-level voltage Vs and emitters of the transistors Ys and Xs are connected to the Y-electrode and the X-electrode, respectively. Emitters of the transistors Yg and Xg are connected to a power supply (i.e., a ground terminal) that supplies the low-level voltage 0V and collectors of the transistors Yg and Xg are connected to the Y-electrode and the X-electrode, respectively.

The energy recovery unit 220 includes the transistors Yr and Yf, an inductor Ly, and a capacitor Cerc. The energy recovery unit 420 includes the transistor Xr. An emitter of the transistor Yr is connected to the Y-electrode and a collector of the transistor Yr is connected to a first terminal of the inductor Ly. A second terminal of the inductor Ly is connected to a collector of the transistor Yf and the capacitor Cerc is connected between an emitter of the transistor Yf and the ground terminal. At this time, the capacitor Cerc supplies voltages between the high-level voltage Vs and the low-level voltage 0V. For example, the capacitor Cerc supplies an intermediate voltage Vs/2 of the two voltages Vs and 0V. Further, an emitter of the transistor Xr is connected to the X-electrode and a collector of the transistor Xr and the collector of the transistor Yf are connected to the harness 24. Because inductance is provided in the harness 24, the energy recovery unit 420 of the sustain driving board 400 may be actually includes the transistor Xr, the harness 24, the transistor Yf, and the capacitor Cerc. That is, the energy recovery units 220 and 440 of the scan and sustain driving boards 200 and 400 are coupled, and commonly use the transistor Yf and the capacitor Cerc.

In some embodiments, an energy recovery unit having the same structure as the energy recovery unit 220 may be included in the sustain driving board 400 and an energy recovery unit having the same structure as the energy recovery unit 420 may be included in the scan driving board 200.

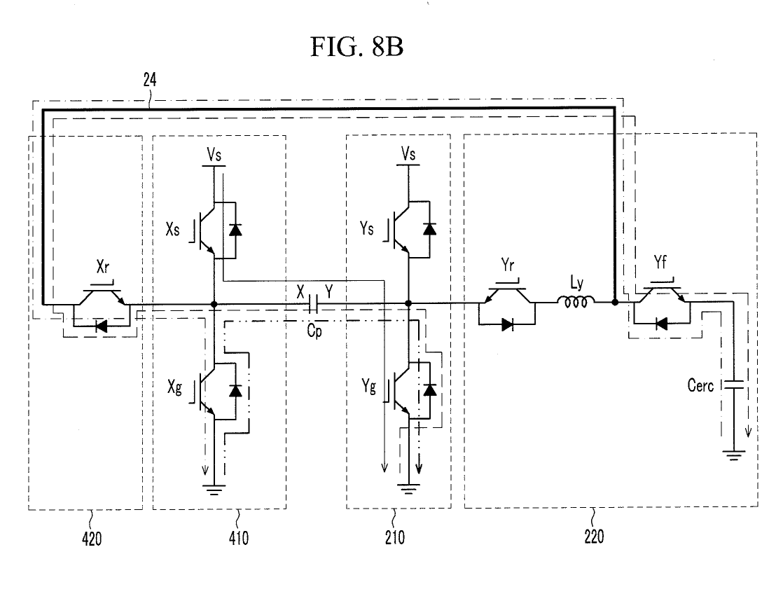

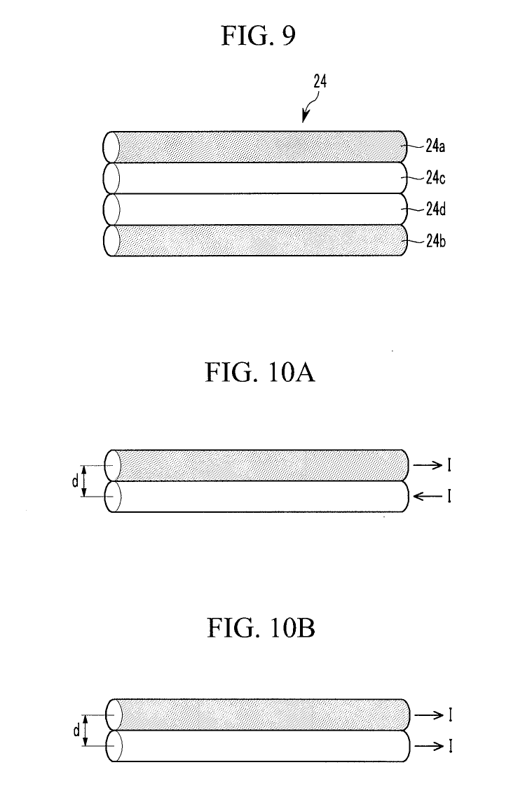

FIG. 7 is a signal timing diagram of the driving circuit of FIG. 6 for generating a sustain pulse shown in FIG. 4. FIGS. 8A and 8B are diagrams illustrating a current path corresponding to signal timing shown in FIG. 6.

Referring to FIGS. 7 and 8A, the transistors Xg and Yg are turned on in mode 1 M1. In this case, the voltage 0V is applied to the X and Y-electrodes by the two transistors Xg and Yg.

In mode 2 M2, the transistor Yr is turned on and the transistor Yg is turned off. As a result, a current path is formed through the ground terminal, the capacitor Cerc, the body diode of the transistor Yf, the inductor Ly, the transistor Yr, the panel capacitor Cp, the transistor Xg, and the ground terminal. While resonance occurs between the inductor Ly and the panel capacitor Cp in the current path, the voltage of the Y-electrode increases to approximately the voltage Vs from the voltage 0V.

In mode 3 M3, the transistor Ys is turned on and the transistor Yr is turned off. In this case, while the current path is formed through the power supply Vs, the transistor Ys, the panel capacitor Cp, the transistor Xg, and the ground terminal, the voltage Vs is applied to the Y-electrode.

In mode 4 M4, the transistor Yf is turned on and the transistor Ys is turned off. In this case, the current path is formed through the ground terminal, the body diode of the transistor Xg, the panel capacitor Cp, the body diode of the transistor Yr, the inductor Ly, the transistor Yf, the capacitor Cerc, and the ground terminal. While the resonance occurs between the inductor Ly and the panel capacitor Cp in the current path, the voltage of the Y-electrode decreases to approximately the voltage 0V from the voltage Vs.

Subsequently, referring to FIGS. 7 and 8B, in mode 5 M5, the transistor Yg is turned on and the transistor Yf is turned off. In this case, the voltage 0V is applied to the X and Y-electrodes by the two transistors Xg and Yg.

In mode 6 M6, the transistor Xr is turned on and the transistor Xg is turned off. In this case, the current path is formed through the ground terminal, the capacitor Cerc, the body diode of the transistor Yf, the harness 24, the transistor Xr, the panel capacitor Cp, the transistor Yg, and the ground terminal. As a result, while the resonance occurs with the inductance of the harness 24 and the panel capacitor Cp, the voltage of the X-electrode increases to approximately the voltage Vs from the voltage 0V.

In mode 7 M7, the transistor Xs is turned on and the transistor Xr is turned off. In this case, while the current path is formed through the power supply Vs, the transistor Xs, the panel capacitor Cp, the transistor Yg, and the ground terminal, the voltage Vs is applied to the X-electrode.

In mode 8 M8, the transistor Yf is turned on and the transistor Xs is turned off. In this case, the current path is formed through the ground terminal, the body diode of the transistor Yg, the panel capacitor Cp, the body diode of the transistor Xr, the harness 24, the transistor Yf, the capacitor Cerc, and the ground terminal. As a result, while the resonance occurs with the inductance of the harness 24 and the panel capacitor Cp, the voltage of the X-electrode decreases to approximately the voltage 0V from the voltage Vs.

The scan and sustain driving boards 200 and 400 can alternately apply sustain pulses having the voltage 0V and the voltage Vs to the Y and X-electrodes by repeating operations of modes 1 to 8 M1 to M8 for the number of times corresponding to the weighted value of the sub-filed of the sustain period.

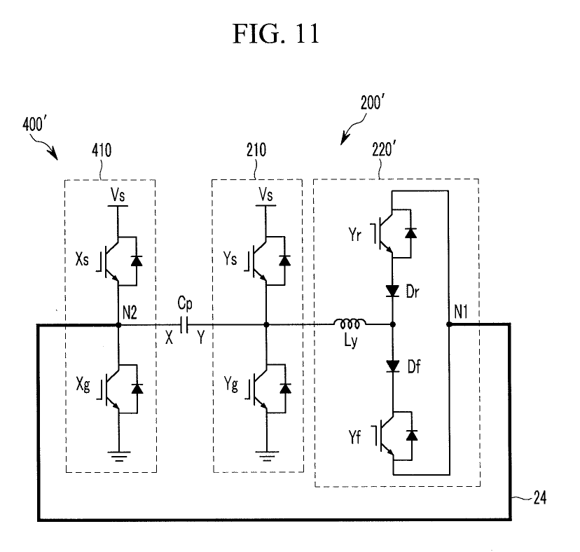

Accordingly, it is possible to reduce the number of circuit elements of the driving circuit by connecting the energy recovery unit 220 of the scan driving board 200 and the energy recovery unit 420 of the sustain driving board 400 to the harness 24, thereby lowering the unit price of the plasma display device. Because energy recovery efficiency varies depending on the structure of the harness 24, a structure of the harness 24 that is capable of improving the energy recovery efficiency will now be described with reference to FIG. 9.

Referring to FIG. 9, this embodiment of the harness 24 includes a plurality of wires (hereinafter, referred to as “ground wire”) 24a and 24b used as a ground (GND) line and a plurality of wires (hereinafter, referred to as “main path wire”) 24c and 24d used as a current line that passes a current. In this case, the ground wires 24a and 24b may be used to connect a ground terminal (that is, a ground terminal connected with the transistor Xg) of the sustain driving board 400 and a ground terminal (that is, a ground terminal connected with the transistor Yg and/or a ground terminal connected with the capacitor Cerc) of the scan driving board 200 to each other in the circuit shown in FIG. 6. Further, as described above, since the current path is formed between the transistor Xr of the sustain driving board 400 and the transistor Yf of the scan driving board 200, the main path wires 24c and 24d may be used to connect the two transistors Xr and Xf to each other.

The ground wires 24a and 24b are disposed at both sides, that is, outside the main path wires 24c and 24d of the harness 24 and the main path wires 24c and 24d are disposed between the ground wires 24a and 24b formed at both sides of the harness 24. In addition, the number of the ground wires 24a and 24b may be the same as the number of the main path wires 24c and 24d. In FIG. 9, although the harness 24 has two current wires and two ground wires, the harness 24 may have two or more main current paths and two or more ground wires. For example, in the case in which the harness 24 has four main path wires and four ground wires, two pairs of ground wires may be disposed at both sides of the harness 24 and four current wires may be disposed between the ground wires.

In general, when the current flows in a wire, a magnetic field is formed in the vicinity thereof and the magnetic field varies depending the current flow direction. Further, the inductance occurs because of the influence of the magnetic field. The internal inductance is the same regardless of the number of wires, but external inductance varies depending on the number of wires.

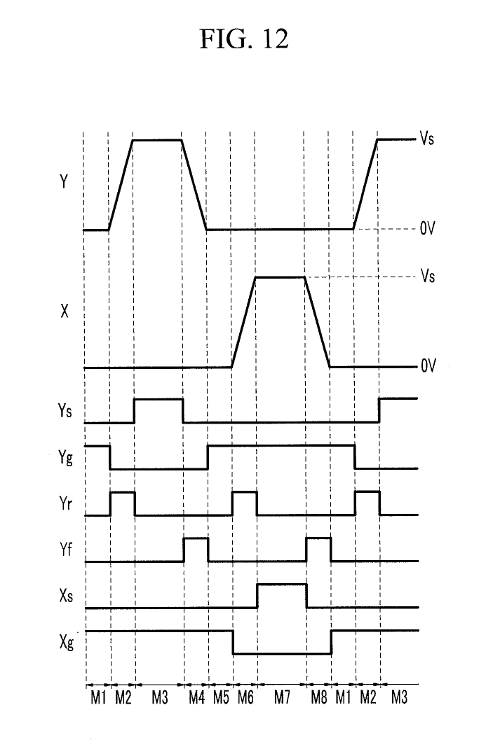

FIGS. 10A and 10B are diagrams illustrating a current in a harness wire. In FIGS. 10A and 10B, only two wires are illustrated.

Inductance L per a unit length of the wire may be represented by a sum of internal inductance L, and external inductance Lₑ.

As shown in FIG. 10A, when a current I flows on one wire of two wires and a current −I flows on the other wire, the internal inductance Lᵢ of the wire can be calculated as shown in Equation 1.

$${L}_{i} = 2 \times \frac{{μ}_{0}}{8 π} = \frac{{μ}_{0}}{4 π} \qquad ( Equation 1 )$$

Magnetic flux densities β₁ and β₂ may be determined by Ampere's law as shown in Equations 2 and 3. The magnetic flux density β₁ depends on the current I and the magnetic flux density β₂ depends on the current −I.

$${β}_{1} = \frac{{μ}_{0} I}{2 π x} \qquad ( Equation 2 )$$

Herein, x is a radius of one wire of two wires.

$${β}_{2} = \frac{{μ}_{0} I}{2 π ( d - x )} \qquad ( Equation 3 )$$

Herein, d is a distance between the centers of the two wires and d−x is a radius of the other wire of the two wires.

Total magnetic flux λ is calculated as shown in Equation 4 and the total magnetic flux λ is the external inductance Lₑ.

$$\begin{matrix}λ = \frac{Λ}{h} \\ = {\int }_{a}^{d - a} ( {β}_{1} + {β}_{2} ) \cdot d x \\ = \frac{{μ}_{0} I}{2 π} {\int }_{a}^{d - a} ( \frac{1}{x} + \frac{1}{d - x} ) \cdot d x \\ = {\frac{{μ}_{0} I}{2 π} [ Inx - In ( d - x ) ]}_{a}^{d - a} \\ = \frac{{μ}_{0} I}{π} In ( \frac{d - a}{a} )\end{matrix} \qquad ( Equation 4 )$$

Accordingly, the inductance L may be shown in Equation 5.

$$L = {L}_{i} + {L}_{e} = \frac{{μ}_{0}}{4 π} + \frac{{μ}_{0}}{π} In ( \frac{d - a}{a} ) \qquad ( Equation 5 )$$

Next, as shown in FIG. 10B, when directions of the currents that flows on the two wires are the same as each other, the external inductance Lₑ is 0 as shown in Equation 6 by Ampere's law. Accordingly, the internal inductance Lᵢ is the total inductance L.

$$\begin{matrix}λ = \frac{Λ}{h} \\ = {\int }_{a}^{d - a} ( {β}_{1} - {β}_{2} ) \cdot d x \\ = \frac{{μ}_{0} I}{2 π} {\int }_{a}^{d - a} ( \frac{1}{x} - \frac{1}{d - x} ) \cdot d x \\ = {\frac{{μ}_{0} I}{2 π} [ Inx + In ( d - x ) ]}_{a}^{d - a} \\ = 0\end{matrix} \qquad ( Equation 6 )$$

By this relation, as shown in FIG. 9, when two ground wires 24a and 24b are disposed at both sides and two main path wires 24c and 24d are disposed between the ground wires 24a and 24b, a current direction of the ground wire 24a is opposite to a current direction of the main path wire 24c and a distance between the ground wire 24a and the main path wire 24c is d, such that external inductance Lₑ₁ between the ground wire 24a and the main path wire 24c is

$$- \frac{{μ}_{0}}{π} In ( \frac{d - a}{a} )$$

and the current direction of the ground wire 24a is opposite to a current direction of the main path wire 24d and a distance between the ground wire 24a and the main path wire 24d is 2d, such that external inductance Lₑ₂ between the ground wire 24a and the main path wire 24d is

$$- \frac{{μ}_{0}}{π} In ( \frac{d - a}{a} )$$

Since the current directions of the ground wires 24a and 24b are the same as each other, external inductance Lₑ₃ between the ground wires 24a and 24b is 0. Since the current directions of the main path wires 24c and 24d also are the same as each other, external inductance Lₑ₄ between the main path wires 24c and 24d is 0. Further, the current direction of the main path wire 24c is opposite to the current direction of the ground wire 24b and a distance between the main path wire 24c and the ground wire 24b is 2d, such that external inductance Lₑ₅ between the main path wire 24c and the ground wire 24b is

$$\frac{{μ}_{0}}{π} In ( \frac{2 d - a}{a} ) .$$

The current direction of the main path wire 24d is opposite to the current direction of the ground wire 24b and a distance between the main path wire 24d and the ground wire 24b is d, such that external inductance Lₑ₆ between the main path wire 24d and the ground wire 24b is

$$\frac{{μ}_{0}}{π} In ( \frac{d - a}{a} ) .$$

Accordingly, the total external inductance Lₑ of the harness 24 shown in FIG. 9 is equal to a sum of the external inductances Lₑ₁ to Lₑ₆, such that the total external inductance Lₑ of the harness 24 is 0. That is, only the inductance for the harness 24 is provided. As such, since the external inductance of the harness 24 may be removed, the energy recovery unit 420 of the sustain driving board 400 can form the resonance by using the inductance element of the harness 24, thereby improving the energy recovery efficiency.

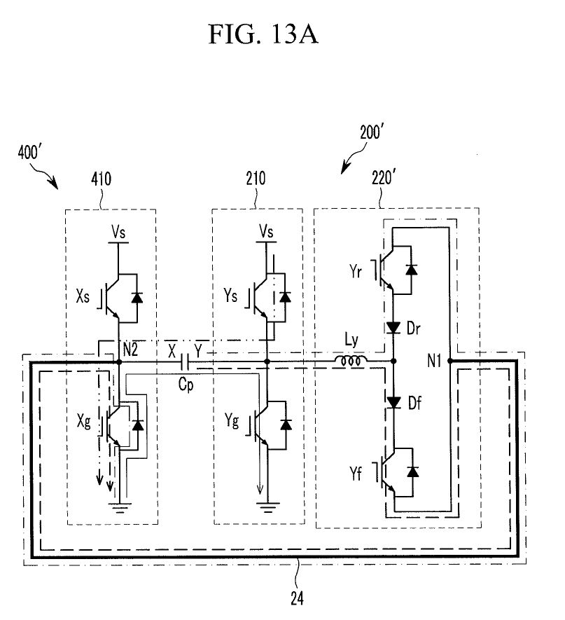

FIG. 11 is a diagram illustrating a driving circuit according to a second exemplary embodiment.

As shown in FIG. 11, a scan driving board 200′ has the same structure as the scan driving board 200 according to the exemplary embodiment of FIG. 6 except for the energy recovery unit 220′. A sustain driving board 400′ does not include the energy recovery unit 420 of the embodiment of FIG. 6. In the embodiment of FIG. 11, the energy recovery unit 220′ is included in the scan driving board 200′, but the energy recovery unit 220′ may be included in the sustain driving board 400′ and the energy recovery unit 220′ may not provided in the scan driving board 200′.

The energy recovery unit 220′ includes transistors Yr and Yf and an inductor Ly. A first terminal of the inductor Ly is connected to a Y-electrode and a second terminal of the inductor Ly is connected to an emitter of the transistor Yr and a collector of the transistor Yf. A collector of the transistor Yr and an emitter of the transistor Yf are connected to a node N1. The node N1 and a node N2 corresponding to a contact point between an emitter of a transistor Xs and a collector of the transistor Xg are connected to a harness 24.

Further, a cathode of a diode Dr is connected to a second terminal of the inductor Ly and an anode of the diode Dr is connected to the emitter of the transistor Yr. An anode of a diode Df is connected to the second terminal of the inductor Ly and a cathode of the diode Df is connected to the collector of the transistor Yf. The diode Dr establishes a current path (hereinafter, referred to as “rising path”) for increasing a voltage of the Y-electrode and the diode Df establishes a current path (hereinafter, referred to as “falling path”) for decreasing the voltage of the Y-electrode. In addition, a position of the diode Dr and a position of the transistor Yr may be exchanged and a position of the diode Df and a position of the transistor Yf may be exchanged.

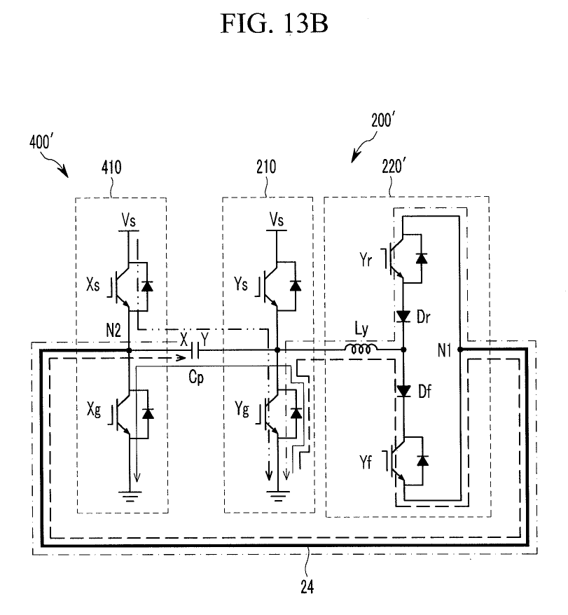

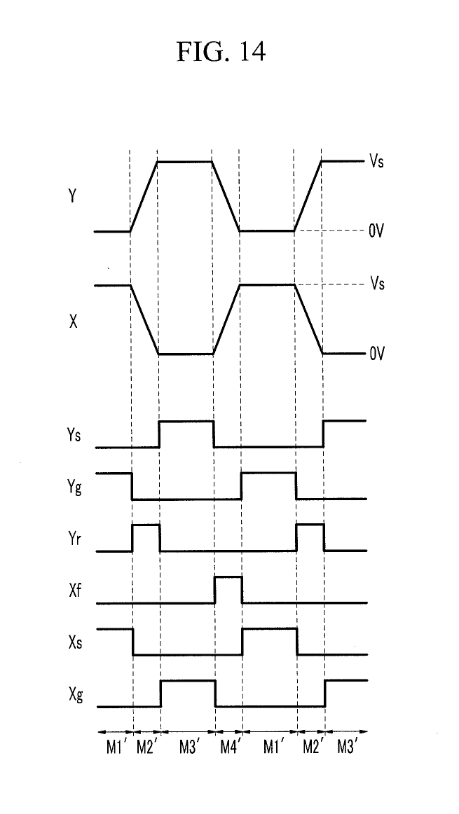

FIG. 12 is a signal timing diagram of the driving circuit of FIG. 11 for generating a sustain pulse shown in FIG. 4. FIGS. 13A and 13B are diagrams illustrating current paths corresponding to signal timing shown in FIG. 12.

Referring to FIGS. 12 and 13A, the transistor Xg and a transistor Yg are turned on in mode 1 M1. In this case, a voltage 0V is applied to an X electrode and the Y-electrode by the two transistors Xg and Yg.

In mode 2 M2, the transistor Yr is turned on and the transistor Yg is turned off. In this case, a current path is formed through a ground terminal, a body diode of the transistor Xg, the transistor Yr, the diode Dr, the inductor Ly, and a Y-electrode of the panel capacitor Cp. Because resonance occurs between the inductor Ly and the panel capacitor Cp by the current path, the voltage of the Y-electrode increases to approximately a voltage Vs from the voltage 0V.

In mode 3 M3, a transistor Ys is turned on and the transistor Yr is turned off. In this case, a current path is formed through a power supply Vs, the transistor Ys, the panel capacitor Cp, the transistor Xg, and the ground terminal. In response, the voltage Vs is applied to the Y-electrode.

In mode 4 M4, the transistor Yf is turned on and the transistor Ys is turned off. In this case, a current path is formed through the Y-electrode of the panel capacitor Cp, the inductor Ly, the diode Df, the transistor Yf, the transistor Xg, and the ground terminal. Because resonance occurs between the inductor Ly and the panel capacitor Cp in the current path, the voltage of the Y-electrode decreases to approximately the voltage 0V from the voltage Vs.

Subsequently, referring to FIGS. 12 and 13B in mode 5 M5, the transistor Yg is turned on and the transistor Yf is turned off. In this case, the voltage 0V is applied to the Y-electrode by the two transistors Yg and Xg.

In mode 6 M6, the transistor Yr is turned on and the transistor Xg is turned off. In this case, a current path is formed through an X-electrode of the panel capacitor Cp, the transistor Yr, the diode Dr, the inductor Ly, the transistor Yg, and the ground terminal. Because resonance occurs between the inductor Ly and the panel capacitor Cp in the current path, the voltage of the X-electrode increases to approximately the voltage Vs from the voltage 0V.

In mode 7 M7, the transistor Xs is turned on and the transistor Yr is turned off. In this case, a current path is formed through the power supply Vs, the transistor Xs, the panel capacitor Cp, the transistor Yg, and the ground terminal, and the voltage Vs is applied to the X-electrode.

In mode 8 M8, the transistor Yf is turned on and the transistor Xs is turned off. In this case, a current path is formed through the ground terminal, a body diode of the transistor Yg, the inductor Ly, the diode Df, the transistor Yf, and the X-electrode of the panel capacitor Cp. Because resonance occurs between the inductor Ly and the panel capacitor Cp in the current path, the voltage of the X-electrode decreases to approximately the voltage 0V from the voltage Vs.

In addition, the scan and sustain driving boards 200 and 400 can alternately apply sustain pulses to the Y and X-electrodes by repeating operations of modes 1 to 8 M1 to M8 a number of times corresponding to the weighted value during the sustain period of the sub-field.

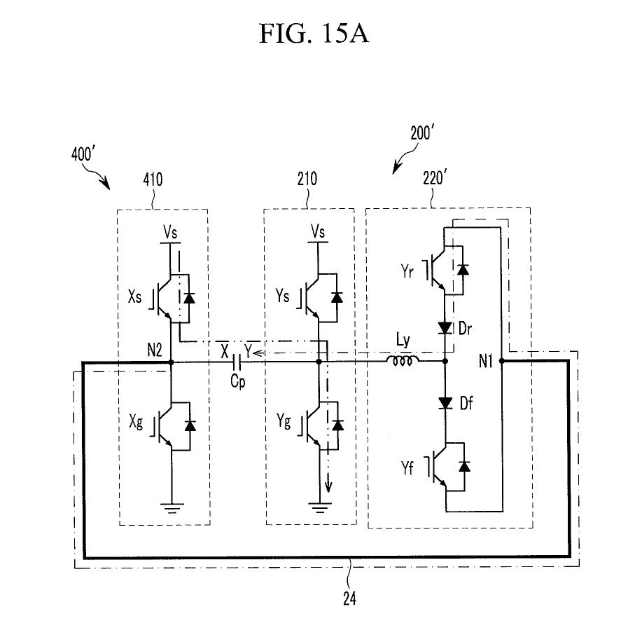

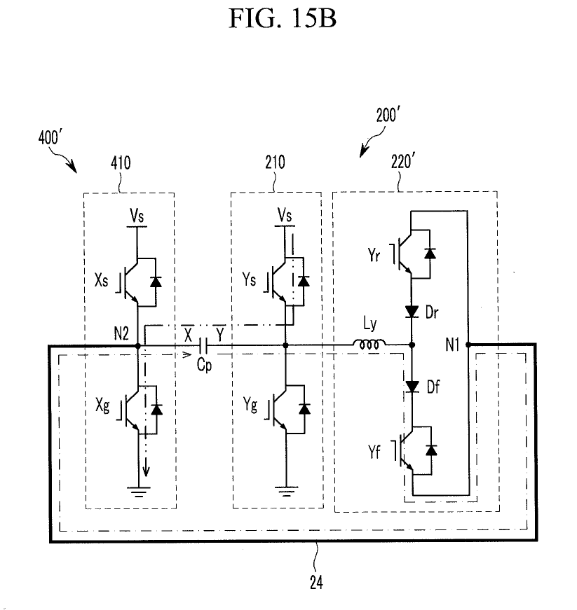

FIG. 14 is a signal timing diagram of the driving circuit of FIG. 11 for generating the sustain pulse shown in FIG. 5. FIGS. 15A and 15B are diagrams illustrating current paths corresponding to signal timing shown in FIG. 14.

Referring to FIGS. 14 and 15A, the transistors Yg and Xg are turned on in mode 1′ M1′. In this case, a current path is formed through the power supply Vs, the transistor Xs, the panel capacitor Cp, the transistor Yg, and the ground terminal, and the voltage Vs is applied to the X-electrode and the voltage 0V is applied to the Y-electrode.

In mode 2′ M2′, the transistor Yr is turned on and the transistors Yg and Xs are turned off. In this case, a current path is formed through the X-electrode of the panel capacitor Cp, the harness 24, the transistor Yr, the diode Dr, the inductor Ly, and the Y-electrode of the panel capacitor Cp. Because resonance occurs between the inductor Ly and the panel capacitor Cp in the current path, the voltage of the X-electrode decreases to approximately the voltage 0V from the voltage Vs and the voltage of the Y-electrode increases to approximately the voltage Vs from the voltage 0V.

Subsequently, referring to FIGS. 14 and 15B, in mode 3′ M3′, the transistors Ys and Xg are turned on and the transistor Yf is turned off. In this case, a current path is formed through the power supply Vs, the transistor Ys, the panel capacitor Cp, the transistor Xg, and the ground terminal, and the voltage Vs is applied to the Y-electrode and the voltage 0V is applied to the X-electrode.

In mode 4′ M4′, the transistor Xr is turned on and the transistors Ys and Xg are turned off. In this case, a current path is formed through the Y-electrode of the panel capacitor Cp, the inductor Ly, the diode Df, the transistor Yf, the harness 24, and the X-electrode of the panel capacitor Cp. Because resonance occurs between the inductor Ly and the panel capacitor Cp in the current path, the voltage of the Y-electrode decreases to approximately the voltage 0V from the voltage Vs and the voltage of the X-electrode increases to approximately the voltage Vs from the voltage 0V.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display, comprising:
first and second electrodes that extend in one direction;
a first driving unit configured to apply a first sustain pulse alternately having first and second voltages to the first electrode during a sustain period;
a second driving unit configured to apply a second sustain pulse alternately having third and fourth voltages to the second electrode in a phase opposite to the first sustain pulse during the sustain period; and
a harness connecting the first driving unit and the second driving unit to each other,
wherein the harness includes:
a plurality of ground wires; and
a plurality of main path wires that are disposed between the plurality of ground wires.

2. The plasma display of claim 1, wherein the number of ground wires is the same as the number of main path wires.

3. The plasma display of claim 2, wherein the first driving unit comprises:
a capacitor configured to supply a voltage between the first voltage and the second voltage;
an inductor, wherein a first terminal of the inductor is connected to the first electrode and a second terminal of the inductor is connected to the capacitor; and
a first transistor connected between the first electrode and the first terminal of the inductor,
and wherein the second driving unit includes:
a second transistor, wherein a first terminal of the second transistor is connected to the second electrode,
and wherein a second terminal of the inductor and a second terminal of the second transistor are connected to the harness.

4. The plasma display of claim 3, wherein the first driving unit further comprises a third transistor that is connected between the second terminal of the inductor and the capacitor.

5. The plasma display of claim 4, wherein each of the first, second, and third transistors includes a body diode.

6. The plasma display of claim 2, wherein the first driving unit comprises:
an inductor, wherein a first terminal of the inductor is connected to the first electrode;
a first transistor connected between the second terminal of the inductor and a node; and
a second transistor connected between the second terminal of the inductor and the node,
wherein the node is connected to the second electrode and to the harness.

7. The plasma display of claim 2, wherein the first driving unit further comprises:
a first diode connected between the second terminal of the inductor and the first transistor or between the first transistor and the node and allows a current to flow to the first terminal of the inductor from the second terminal of the inductor; and
a second diode connected between the second terminal of the inductor and the second transistor or between the second transistor and the node and allows the current to flow to the second terminal of the inductor from the first terminal of the inductor.

8. The plasma display of claim 3, wherein the first driving unit further comprises:
a fourth transistor connected between a first power supply and the first electrode, wherein the first power supply is configured to supply the first voltage; and
a fifth transistor connected between a second power supply and the first electrode, wherein the second power supply is configured to supply the second voltage,
and wherein the second driving unit further comprises:
a sixth transistor connected between a third power supply and the second electrode, wherein the third power supply is configured to supply the third voltage; and
a seventh transistor connected between a fourth power supply and the second electrode, wherein the fourth power supply is configured to supply the fourth voltage,
and wherein each of the fifth and seventh transistors includes a body diode.

9. The plasma display of claim 8, wherein the second power supply and the fourth power supply are connected to at least one wire of the plurality of ground wires of the harness.

10. A driving apparatus of a plasma display including first and second electrodes that extend in one direction, the driving apparatus comprising:
a first driving board configured to drive the first electrode;
a second driving board configured to drive the second electrode; and
a harness connecting the first driving board and the second driving board,
wherein the harness comprises:
a plurality of ground wires; and
a plurality of main path wires that are disposed between the plurality of ground wires.

11. The driving apparatus of claim 10, wherein the number of ground wires is the same as the number of main path wires.

12. The driving apparatus of claim 11, wherein the first driving board comprises:
an inductor and a first transistor that are connected in series between the first electrode and a node, and
the second driving board comprises:
a second transistor of which a first terminal is connected to the second electrode,
wherein the node and a second terminal of the second transistor are connected to the harness.

13. The driving apparatus of claim 12, wherein each of the first and second transistors comprises a body diode.

14. The driving apparatus of claim 12, wherein the first driving board further comprises:
a capacitor configured to supply a first voltage; and
a third transistor connected between the capacitor and the node.

15. The driving apparatus of claim 11, wherein the first driving board comprises:
an inductor of which a first terminal is connected to the first electrode;
a first diode and a first transistor connected in series between a second terminal of the inductor and the node; and
a second diode and a second transistor connected in series between the second terminal of the inductor and the node,
wherein the node and the second electrode are connected to the harness.

16. The driving apparatus of claim 12, wherein the first driving board further comprises:
a fourth transistor connected between a first power supply and the first electrode, wherein the first power supply is configured to supply a second voltage; and
a fifth transistor connected between a second power supply and the first electrode, wherein the first power supply is configured to supply a second voltage, and
the second driving board further comprises:
a sixth transistor connected between the first power supply and the second electrode; and
a seventh transistor connected between the second power supply and the second electrode,
wherein each of the fifth and seventh transistors includes a body diode.

17. The driving apparatus of claim 16, wherein the second power supply is connected to at least one of the plurality of ground wires.

18. The driving apparatus of claim 16, wherein during a sustain period, the third voltage is applied to the second electrode while the second voltage is applied to the first electrode and the second voltage is applied to the second electrode while the third voltage is applied to the first electrode.

19. A plasma display, comprising:
first and second driving units configured to apply sustain pulses to first and second electrodes during a sustain period; and
a harness connecting the first driving unit and the second driving unit, wherein the harness comprises:
a plurality of ground wires; and
a plurality of main path wires that are disposed between the plurality of ground wires,
and wherein the harness forms an inductive component of an energy recovery circuit for the first and second driving units.

20. The plasma display of claim 19, wherein the number of ground wires is the same as the number of main path wires.
